(19) United States
(12) Patent Application Publication
(10) Pub. No.: US 2019/0340713 A1
(43) Pub. Date: Nov. 7, 2019

(54) SYSTEM AND METHOD FOR GENERATING A DOCUMENT BASED ON RETRIEVED DATA

(71) Applicant: Stoa Fund Ltd., Tel Aviv (IL)

(72) Inventors: Tom SELLA, Miami, FL (US); Or AGASSI, Tel Aviv (IL)

(73) Assignee: Stoa Fund Ltd., Tel Aviv (IL)

(21) Appl. No.: 16/400,490

(22) Filed: May 1, 2019

Related U.S. Application Data
(60) Provisional application No. 62/665,529, filed on May 2, 2018.

(51) Int. Cl. G06Q 50/16; G06Q 50/18; G06Q 40/02; G06F 17/28; G06F 16/29; G06N 3/08

(52) U.S. Cl. CPC G06Q 50/167; G06Q 50/18; G06N 3/08; G06F 17/2881; G06F 16/29; G06Q 40/025

(57) ABSTRACT

A system and method for generating a document, including: retrieving data related to a real estate property, wherein the data includes data related to a borrower, at least a first indication related to the real estate property, and at least a second indication related to an anticipated transaction; analyzing the retrieved data to determine a type of security related to the real estate property; and generating a document based on the type of security and the retrieved data.

### CROSS-REFERENCE TO RELATED APPLICATIONS

This application claims the benefit of U.S. Provisional Application No. 62/665,529 filed on May 2, 2018, the contents of which are hereby incorporated by reference.

### BACKGROUND

Although technological advances have been introduced in most industrial areas to improve efficiency and productivity, the real estate domain currently employs a significant use of manual labor to perform tedious and costly steps. House flipping is a category of real estate investment in which an investor purchases properties, often residential ones, with the goal of reselling them at a profit. The profit is generated either through a price appreciation that occurs as a result of a hot housing market and/or from developments and capital improvements to the property. House flipping investors, however, face the risk of price depreciation in bad housing markets.

Investors who flip houses expect to generate a relatively high return on properties purchased, but may encounter cash-flow difficulties due to the nature of employing such strategies. Such investors typically outsource financing from different entities such as banks, other financial institutes, or private lenders. The loan process is typically a burden to the investor, who frequently must work within a limited time frame and can face numerous regulatory and administrative hurdles. Applying for loans and waiting for the approval process to be complete can frustrate the house flipping process and cause loss of income and lost investment opportunities.

It would therefore be advantageous to provide a solution that would overcome the challenges noted above.

### SUMMARY

A summary of several example embodiments of the disclosure follows. This summary is provided for the convenience of the reader to provide a basic understanding of such embodiments and does not wholly define the breadth of the disclosure. This summary is not an extensive overview of all contemplated embodiments, and is intended to neither identify key or critical elements of all embodiments nor to delineate the scope of any or all aspects. Its sole purpose is to present some concepts of one or more embodiments in a simplified form as a prelude to the more detailed description that is presented later. For convenience, the term “certain embodiments” may be used herein to refer to a single embodiment or multiple embodiments of the disclosure.

Certain embodiments disclosed herein include a method for generating a document based on retrieved data, including: retrieving data related to a real estate property, wherein the data includes data related to a borrower, at least a first indication related to the real estate property, and at least a second indication related to an anticipated transaction; analyzing the retrieved data to determine a type of security related to the real estate property; and generating a document based on the type of security and the retrieved data.

Certain embodiments disclosed herein also include a non-transitory computer readable medium having stored thereon instructions for causing a processing circuitry to perform a process, the process including: retrieving data related to a real estate property, wherein the data includes data related to a borrower, at least a first indication related to the real estate property, and at least a second indication related to an anticipated transaction; analyzing the retrieved data to determine a type of security related to the real estate property; and generating a document based on the type of security and the retrieved data.

Certain embodiments disclosed herein also include a system for generating a document based on retrieved data, including: a processing circuitry; and a memory, the memory containing instructions that, when executed by the processing circuitry, configure the system to: retrieve data related to a real estate property, wherein the data includes data related to a borrower, at least a first indication related to the real estate property, and at least a second indication related to an anticipated transaction; analyze the retrieved data to determine a type of security related to the real estate property; and generate a document based on the type of security and the retrieved data.

### BRIEF DESCRIPTION OF THE DRAWINGS

The subject matter disclosed herein is particularly pointed out and distinctly claimed in the claims at the conclusion of the specification. The foregoing and other objects, features, and advantages of the disclosed embodiments will be apparent from the following detailed description taken in conjunction with the accompanying drawings.

FIG. 1 is a block diagram of a document generation system according to an embodiment.

FIG. 2 is an example flowchart describing a method for generating a document according to an embodiment.

FIG. 3 is an example flowchart describing a method for validating a document according to an embodiment.

### DETAILED DESCRIPTION

It is important to note that the embodiments disclosed herein are only examples of the many advantageous uses of the innovative teachings herein. In general, statements made in the specification of the present application do not necessarily limit any of the various claimed embodiments. Moreover, some statements may apply to some inventive features but not to others. In general, unless otherwise indicated, singular elements may be in plural and vice versa with no loss of generality. In the drawings, like numerals refer to like parts through several views.

The various disclosed embodiments include a method and system for generating a document, such as a security agreement with respect to a real estate property. The request includes data related to a borrower, at least a first indication related to the real estate property, and at least a second indication related to an associated transaction. The system then extracts data related to the real estate property and generates a type of security required based on an analysis of the at least a first indication and the at least a second indication. Thereafter, the system automatically generates a document, e.g., a security agreement, between the borrower and a lender. The system can further validate the document upon request and submit it to a dispatcher.

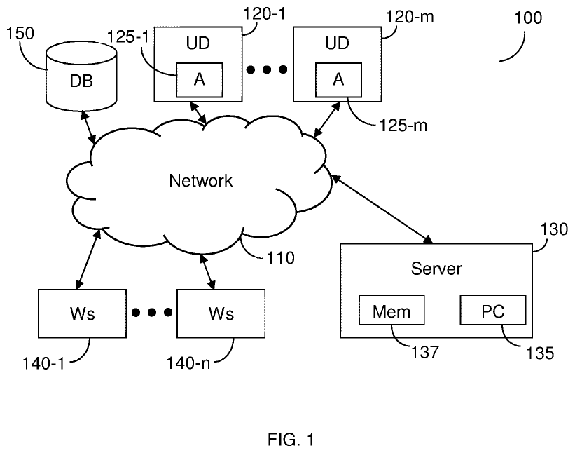

FIG. 1 is a block diagram of an automated document generation system 100 according to an embodiment. A network 110 is used to communicate between different parts of the system 100. The network 110 may be the Internet, the world-wide-web (WWW), a local area network (LAN), a wide area network (WAN), a metro area network (MAN), and other networks capable of enabling communication between the elements of the system 100.

One or more user devices 120-1 through 120-m, where m is an integer equal to or greater than 1, hereinafter user device 120 or user devices 120, are further connected to the network 110. A user device 120 may be, for example, a personal computer (PC), a personal digital assistant (PDA), a mobile phone, a smart phone, a tablet computer, an electronic wearable device (e.g., glasses, a watch, etc.), a smart television, and similar wired and mobile devices equipped with browsing, viewing, capturing, storing, listening, filtering, and managing capabilities enabled as further discussed herein below. The user devices 120 may be operated by a lender, a borrower, a realtor, a banker, and the like.

Each user device 120 may further include a software application (App) 125 installed thereon. A software application App 125 may be downloaded from an application repository, such as the Google® AppStore®, Google Play®, or any repositories hosting software applications. The application 125 may be pre-installed in the user device 120. In one embodiment, the application 125 is a web-browser.

A server 130 is coupled to the user device 120 and can communicate therewith using the application 125 via the network 110. The server 130 typically comprises a processing circuitry 135 and a memory 137. The server 130 also includes a network interface (not shown) configured to connect to the network 110.

The processing circuitry 135 may be realized as one or more hardware logic components and circuits. For example, and without limitation, illustrative types of hardware logic components that can be used include field programmable gate arrays (FPGAs), application-specific integrated circuits (ASICs), application-specific standard products (ASSPs), system-on-a-chip systems (SOCs), general-purpose microprocessors, microcontrollers, digital signal processors (DSPs), and the like, or any other hardware logic components that can perform calculations or other manipulations of information.

In another embodiment, the memory 137 is configured to store software. Software shall be construed broadly to mean any type of instructions, whether referred to as software, firmware, middleware, microcode, hardware description language, or otherwise. Instructions may include code (e.g., in source code format, binary code format, executable code format, or any other suitable format of code). The instructions cause the processing circuitry 137 to perform the various processes described herein.

It should be noted that only one user device 120 and one application 125 are discussed herein merely for the sake of simplicity. However, the embodiments disclosed herein are applicable to a plurality of user devices that can communicate with the server 130 via the network 110.

The server 130 is configured to communicate via the network 110 with one or more web sources 140-1 through 140-n, where n is an integer equal to or greater than 1, hereinafter referred to as web source 140 or web sources 140. The web sources 140 may be, for example, one or more regulatory data sources and/or tax or municipal authorities, geographic information systems (GISs), federal and/or governmental sources, and the like.

A database 150 is further connected to the network 110 and configured to store metadata related to certain property transactions, data extracted from web sources 140 and more. In the embodiment illustrated in FIG. 1, the server 130 communicatively communicates with the database 150 through the network 110.

According to an embodiment, the server 130 receives a request, e.g., from a user device 120, to generate a document, e.g., a security agreement with respect to a real estate property. The real estate property may include any type of property, such as, a house, a villa, a condo, a shop, a building, a tower, land, and the like.

The security agreement is to set a collateral for the lender with respect of the loan, e.g., a mortgage on the property. The request includes data related to the borrower, at least a first indication related to the property and at least a second indication related to the transaction. The request may further include data related to the lender. Alternatively, the data related to the lender or the borrower may be identified based on the user device from which the request was received.

According to an embodiment, the request may include a sale agreement which will be analyzed by the server 130 using one or more computer vision techniques, such as optical character recognition (OCR), deep learning, machine learning, a combination thereof, and the like. Based on the analysis, the indications related to the property and the borrower are identified by the server 130.

Indications related to the property may include, for example, a visual representation of the property, e.g., an image or video, a street address, GIS coordinates, lot or parcel data, and the like. Indications related to the borrower may include, for example, a name, an identification number, e.g., a license or passport number, a credit score, a registration number, a home or headquarters address, or any other identifying characteristics. The borrower may be a person or an entity, such as a company.

Indications related to the transaction may include, for example, an amount of a requested loan, terms and conditions, country of which the transaction is subject to, signatories, regulatory data, and the like.

Based on the first indication, the server 130 is configured to extract additional data related to the property from one or more of the web sources 140. Thereafter, the server 130 is configured to determine a type of security, e.g., a mortgage, based on an analysis of at least one of: the at least a first indication, the at least a second indication, the extracted data, portion thereof or a combination thereof.

Thereafter, the server 130 is configured to generate a document, e.g., a security agreement, based on at least the type of the security, the extracted data and the data related to the borrower. The generation of the document may include extraction of a draft agreement from the database 150.

The security agreement may then be sent by the server 130 via the network 110 to one or more of the user devices 120. According to another embodiment, the security agreement may be submitted to a website associated with a financial or governmental authority, a bank, a lender, and the like.

According to yet another embodiment, the server 130 may validate the security agreement before submission, either automatically or based on a request received from a user device 120 or a web source 140. Subject to receiving a request for validation, the security agreement is analyzed by the server 130. The analysis may include one or more computer vision techniques, or machine learning techniques discussed above. Based on the analysis, at least one draft similar to the security agreement is extracted from the database 150.

Based on the extracted draft, requirements for validation of the agreement are identified. According to an embodiment, the requirements for validation may be identified by querying one or more of the web sources 140. The requirements may be, for example, that the agreement is duly signed, properly executed, appendices and details regarding the property are included, terms are defined and sufficiently clarified, and the like.

The server 130 then determines whether the requirements were met. If one or more requirements were not met, a notification is generated by the server 130 that includes an indication thereof. If all requirements have been met, a confirmation may be provided. It should be noted that the validation described herein may also be used as a threshold by a web source 140 for confirming securities' agreements.

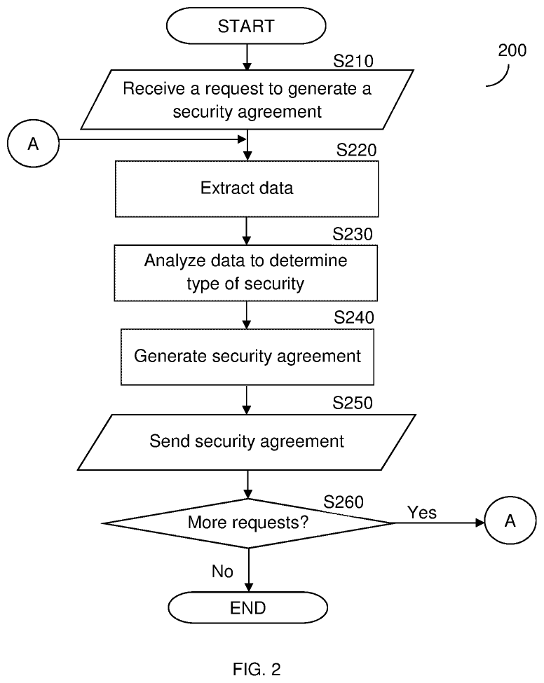

FIG. 2 is an example flowchart 200 describing a method for generating a document over the web according to an embodiment. At S210, the operation starts when a request to generate a document, such as a security agreement. is received. The request may be received from, for example, a user device or a web source. The request includes data related to a borrower, the real estate property and the associated anticipated transaction.

At S220, data associated with the property is retrieved, e.g., from one or more of the web sources or user devices. The data may include a first indication related to the real estate property and a second indication related to the transaction. In an embodiment, the retrieved data may be identified based on a user device from which the request was received. The first indication may include images or videos of the property, a street address, GIS coordinates, lot or parcel data, and the like. The second indication may include loan or property value amounts, timelines of property purchase and any anticipated renovations, property usage and type, and the like. In a further embodiment, the data includes information about a potential borrower or lender as well.

At S230, analyzing the retrieved data to determine a type of security related to the real estate property. The type of security may include a mortgage, a loan collateral, a secured promissory note, and the like. In an embodiment, the type of security is determined using machine learning techniques, e.g., deep learning, neural networks, such as deep convolutional neural network, recurrent neural networks, decision tree learning, Bayesian networks, clustering, and the like.

At S240, a document, e.g., a security agreement, is generated based on the type of security, the extracted data and the borrower's data. In an embodiment, the security agreement is generated based on similar security agreements retrieved from a database having characteristics that match the retrieved data above a predefined threshold. In further embodiment, the security agreement is generated using machine learning techniques mentioned above.

At optional S250, the document is sent to a device, e.g., a user device via a network as per the request. At S260, it is checked if additional requests have been received, and if so, execution continues with S220; otherwise, execution terminates.

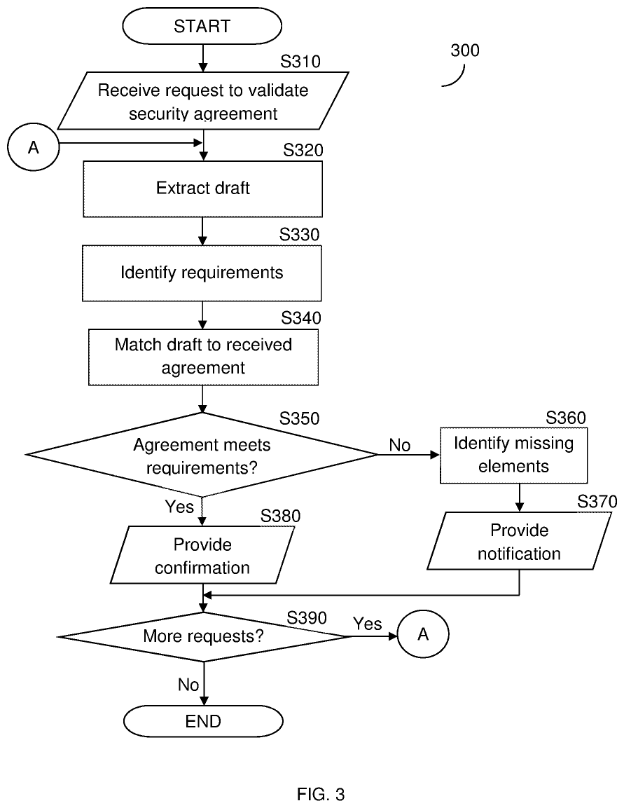

FIG. 3 is an example flowchart 300 describing a method for validating a document over the web according to an embodiment. At S310, the operation starts when a request to validate a document, such as a security agreement over the web, is received. The request may include a scan and/or image of the security agreement.

At optional S320, a draft corresponding to the security agreement is extracted from the database 150. At S330, requirements for validating the security agreement are identified. The requirements may be retrieved from an external database, e.g., a regulatory website, from a lender website, and the like. Additionally, requirements from similar agreements, e.g., accessed from a databases, may be used if the security agreement match the similar agreements above a predetermined threshold.

At S340, the extracted draft is matched to the agreement. Various computer vision techniques, such as optical character recognition (OCR), deep learning, machine learning, a combination thereof, and the like, may be used to match the extracted draft to the agreement.

At S350, it is determined whether the generated security agreement meets the requirements and if so, execution continues with S380; otherwise, execution continues with S360. At S360, the missing elements are identified based on the requirements and execution continues with S370. At S370, a notification indicative of the missing elements is provided and execution continues with S390.

At S380, a confirmation of validation is provided. At S390, it is checked whether there are additional requests and if so, execution continues with S320; otherwise, execution terminates.

The various embodiments disclosed herein can be implemented as hardware, firmware, software, or any combination thereof. Moreover, the software is preferably implemented as an application program tangibly embodied on a program storage unit or computer readable medium consisting of parts, or of certain devices and/or a combination of devices. The application program may be uploaded to, and executed by, a machine comprising any suitable architecture. Preferably, the machine is implemented on a computer platform having hardware such as one or more central processing units (“CPUs”), a memory, and input/output interfaces. The computer platform may also include an operating system and microinstruction code. The various processes and functions described herein may be either part of the microinstruction code or part of the application program, or any combination thereof, which may be executed by a CPU, whether or not such a computer or processor is explicitly shown. In addition, various other peripheral units may be connected to the computer platform such as an additional data storage unit and a printing unit. Furthermore, a non-transitory computer readable medium is any computer readable medium except for a transitory propagating signal.

As used herein, the phrase “at least one of” followed by a listing of items means that any of the listed items can be utilized individually, or any combination of two or more of the listed items can be utilized. For example, if a system is described as including “at least one of A, B, and C,” the system can include A alone; B alone; C alone; A and B in combination; B and C in combination; A and C in combination; or A, B, and C in combination.

All examples and conditional language recited herein are intended for pedagogical purposes to aid the reader in understanding the principles of the disclosed embodiment and the concepts contributed by the inventor to furthering the art, and are to be construed as being without limitation to such specifically recited examples and conditions. Moreover, all statements herein reciting principles, aspects, and embodiments of the disclosed embodiments, as well as specific examples thereof, are intended to encompass both structural and functional equivalents thereof. Additionally, it is intended that such equivalents include both currently known equivalents as well as equivalents developed in the future, i.e., any elements developed that perform the same function, regardless of structure.

What is claimed is:

1. A computerized method for generating a document based on retrieved data, comprising:
retrieving data related to a real estate property, wherein the data includes data related to a borrower, at least a first indication related to the real estate property, and at least a second indication related to an anticipated transaction;
analyzing the retrieved data to determine a type of security related to the real estate property; and
generating a document based on the type of security and the retrieved data.

2. The computerized method of claim 1, wherein the document is a security agreement.

3. The computerized method of claim 1, wherein the first indication includes at least one of: images or videos of the property, a street address, GIS coordinates, and lot or parcel data.

4. The computerized method of claim 1, wherein the type of security is determined using machine learning techniques, including at least one of: deep learning, neural networks, such as deep convolutional neural network, recurrent neural networks, decision tree learning, Bayesian networks, and clustering.

5. The computerized method of claim 1, wherein the type of security includes at least one of: a mortgage, a loan collateral, and a secured promissory note.

6. The computerized method of claim 1, wherein the document is further generated based on similar documents having characteristics that match the retrieved data above a predefined threshold.

7. The computerized method of claim 1, further comprising:
validating the generated document.

8. The computerized method of claim 7, wherein validating the generated document comprises:
identifying validating requirements; and
determining whether the generated document meets the identified validating requirements above a predetermined threshold.

9. The computerized method of claim 7, wherein the validating requirements are retrieved from an external database.

10. A non-transitory computer readable medium having stored thereon instructions for causing a processing circuitry to perform a process, the process comprising:
retrieving data related to a real estate property, wherein the data includes data related to a borrower, at least a first indication related to the real estate property, and at least a second indication related to an anticipated transaction;
analyzing the retrieved data to determine a type of security related to the real estate property; and
generating a document based on the type of security and the retrieved data.

11. A system for generating a document based on retrieved data, comprising:
a processing circuitry; and
a memory, the memory containing instructions that, when executed by the processing circuitry, configure the system to:
retrieve data related to a real estate property, wherein the data includes data related to a borrower, at least a first indication related to the real estate property, and at least a second indication related to an anticipated transaction;
analyze the retrieved data to determine a type of security related to the real estate property; and
generate a document based on the type of security and the retrieved data.

12. The system of claim 11, wherein the document is a security agreement.

13. The system of claim 11, wherein the first indication includes at least one of: images or videos of the property, a street address, GIS coordinates, and lot or parcel data.

14. The system of claim 11, wherein the type of security is determined using machine learning techniques, including at least one of: deep learning, neural networks, such as deep convolutional neural network, recurrent neural networks, decision tree learning, Bayesian networks, and clustering.

15. The system of claim 11, wherein the type of security includes at least one of: a mortgage, a loan collateral, and a secured promissory note.

16. The system of claim 11, wherein the document is further generated based on similar documents having characteristics that match the retrieved data above a predefined threshold.

17. The system of claim 11, wherein the system if further configured to:
validate the generated document.

18. The system of claim 17, wherein validating the generated document comprises:
identifying validating requirements; and
determining whether the generated document meets the identified validating requirements above a predetermined threshold.

19. The system of claim 17, wherein the validating requirements are retrieved from an external database.
